(19) United States
(12) Patent Application Publication
(10) Pub. No.: US 2020/0346534 A1
(43) Pub. Date: Nov. 5, 2020

(54) NON-SYMMETRICAL SEALING ARRANGEMENT FOR NOISE REDUCTION IN A VEHICLE

(71) Applicant: Ford Global Technologies, LLC, Dearborn, MI (US)

(72) Inventors: Patrick Schindler, Köln (DE); Markus Weyand, Odenthal (DE); Johannes Mitschke, Köln (DE)

(21) Appl. No.: 16/837,490

(22) Filed: Apr. 1, 2020

(30) Foreign Application Priority Data
Apr. 30, 2019 (DE) 102019206176.1

(51) Int. Cl. B60J 10/50; B60J 5/10; B60J 10/16; B60J 10/84; B60J 10/70

(52) U.S. Cl. CPC B60J 10/50; B60J 5/10; B60J 10/70; B60J 10/84; B60J 10/16

(57) ABSTRACT

A system for the reduction of noises in an interior of a vehicle includes a closure element, in particular a vehicle door or a window element, closing an opening of a body of the vehicle. A sealing arrangement is provided between the opening and the closure element. The sealing arrangement includes at least a first sealing element and a second sealing element. The rigidity of the first sealing element differs from the rigidity of the second sealing element.

### CROSS-REFERENCE TO RELATED APPLICATIONS

This application claims priority to DE Patent Application No. 102019206176.1, which was filed on 30 Apr. 2019 and is incorporated herein by reference in its entirety.

### TECHNICAL FIELD

The present disclosure relates to a system for the reduction of noises in an interior of a vehicle. The present disclosure furthermore relates to a vehicle comprising such a system for the reduction of noises.

### BACKGROUND

Noises in the interior of a vehicle, for example in a driver's compartment, are unavoidable and can be attributed, for example, to the vibration of the vehicle body or individual vehicle parts, in particular to vibrations of closure elements, such as window elements or vehicle doors, during the journey. Vibrations of window elements or vehicle doors, especially the rear door or tailgate of a vehicle, can therefore be transmitted to the interior, thereby causing the air volume in the vehicle interior to oscillate. This can lead to an undesired, increased noise level. In this case, the noises in the vehicle interior can effect driving comfort.

A system for the reduction of noises in an interior of a vehicle is known, for example, from US 2005/0199440 A1. According to this, specially designed sealing arrangements are provided, which seal an opening in the body of the vehicle upon its closure by a vehicle door. These sealing arrangements are specially designed for the reduction of noises in that they have integrated sensor elements, which detect and measure vibrations causing undesired noises. The sealing arrangement is furthermore equipped with active material, which, as a reaction to the measured, undesired vibrations, produces actively opposed vibrations, whereby the undesired vibrations are canceled out and the noises to be prevented are suppressed.

The system of US 2005/0199440 A1 can be further optimized in that the sealing arrangement is designed to be less complex and structurally simpler. A solution is desirable, in which there is no need to revert to a complicated configuration of the sealing arrangement and, in particular, to complicated measurement of vibrations which cause noise signals.

### SUMMARY

Embodiments of the present disclosure can provide a cost-effective and structurally simple solution to reduce noises in an interior of a vehicle.

An exemplary embodiment of the present disclosure includes a sealing arrangement of a system. The sealing arrangement can include at least a first sealing element and a second sealing element. A rigidity of the first sealing element differs from the rigidity of the second sealing element.

By designing the various sealing elements of the sealing arrangement with different rigidities, the sealing arrangement is asymmetrical in terms of the rigidity. It has been established that, in this way, the vibrations transmitted to the vehicle interior by the corresponding closure element can be considerably reduced. The asymmetrical coupling or connection of the closure element, for example the vehicle door, to the body of the vehicle, which is realized as a result of the sealing arrangement, which is designed asymmetrically in terms of the rigidity, ensures that the low-frequency oscillations in the vehicle interior, which are caused by the vibrations of the closure element, are reduced. The sealing arrangement which is not mirror-symmetrical in terms of the rigidity therefore enables a cost-effective and structurally simple system in an advantageous manner for the reduction of noises in an interior of a vehicle.

In this case, the first sealing element and the second sealing element can be integral components of the sealing arrangement. However, they can also be designed as independent sealing elements, which are then regularly connected to one another directly or indirectly to form the sealing arrangement.

“Differing rigidity,” for purposes of this disclosure, should be understood to mean that either the first sealing element has a greater rigidity than the second sealing element, or vice versa. In this case, the material property in the form of the rigidity can generally describe the resistance of the first and second sealing element to elastic deformation. The rigidity of a sealing element can be determined, for example, by a measuring technique, in that a test piece of a defined length is compressed and, in the process, the required force is measured via the course of the deformation. The first and second sealing element is, like the overall sealing arrangement, regularly elastically deformed, namely generally compressed, as a result of closing the correspondingly associated closure element, for example a vehicle door.

The closure element of the vehicle can be a vehicle door. The vehicle door can be a rear door or a side door of the vehicle. The rear door or tailgate or the trunk lid can refer to a vehicle door of varying sizes in different vehicle models. The system can also be simultaneously provided both in a rear door and in side doors. The important factor here is merely that the sealing arrangement provided at the respective opening in the vehicle body and therefore at the corresponding vehicle door has at least two different sealing elements, which each have a different rigidity.

Alternatively or equally, the closure element can refer to a window element which can be opened and closed again or to a permanently closed window element, in particular a windshield or a rear window or a panoramic window of the vehicle.

In this case, a sealing arrangement of an opening can also have more sealing elements than only the first sealing element and the second sealing element. However, at least a first sealing element and a second sealing element must have mutually differing rigidities.

In a further exemplary aspect of the foregoing arrangement, the first sealing element and the second sealing element can be arranged at opposite sides of the opening. It has been established that, in this way, the noises of the vehicle can again be further reduced.

In a further exemplary aspect of any of foregoing arrangements, the first sealing element can be provided at a left side of the opening, as seen in the direction of travel of the vehicle, and the second sealing element can be provided at a right side of the opening, as seen in the direction of travel of the vehicle. It has been shown that the noises can be even further reduced when the left-side sealing element sealing an opening in the vehicle body has a different rigidity from that of the right-side sealing element at this opening.

In a further exemplary aspect of any of the foregoing arrangements, the sealing arrangement can be a seal extending completely around the opening. The first sealing element and the second sealing element are parts of the sealing arrangement, which have respectively differing rigidities. In this way, a structurally further simplified system can be achieved, since only individual parts of the overall sealing arrangement sealing the opening in the vehicle body have to have different rigidities.

In a further exemplary aspect of any of the foregoing arrangements, the first sealing element can have at least one stiffening element to achieve an increased rigidity compared to the rigidity of the second sealing element. The rigidity of the sealing element can therefore be set precisely in a simple manner in order to achieve the advantageous system for the reduction of the noises.

In a further exemplary aspect of any of the foregoing arrangements, the first sealing element and the second sealing element can further preferably be formed from a respectively different material. In this way, a secure, uncomplicated system can be achieved, since different rigidities can be selected or set by means of the different materials.

A further exemplary aspect of the foregoing arrangements can include a vehicle having the system.

To avoid unnecessary duplication of effort and repetition of text in the specification, certain features are described in relation to only one or several aspects or embodiments. However, it is to be understood that, where it is technically possible, features described in relation to any aspect or embodiment may also be used with any other aspect or embodiment.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a perspective rear view of a vehicle having a system used in connection with a rear door according to an exemplary embodiment of the present disclosure.

FIG. 2 illustrates the vehicle according to FIG. 1 in a further perspective view, shown laterally from the front, wherein a windshield is shown as an exploded representation to illustrate the system to another exemplary aspect of the present disclosure.

FIG. 3 illustrates a cross-section through a sealing element of the system of FIG. 1 or FIG. 2.

### DETAILED DESCRIPTION

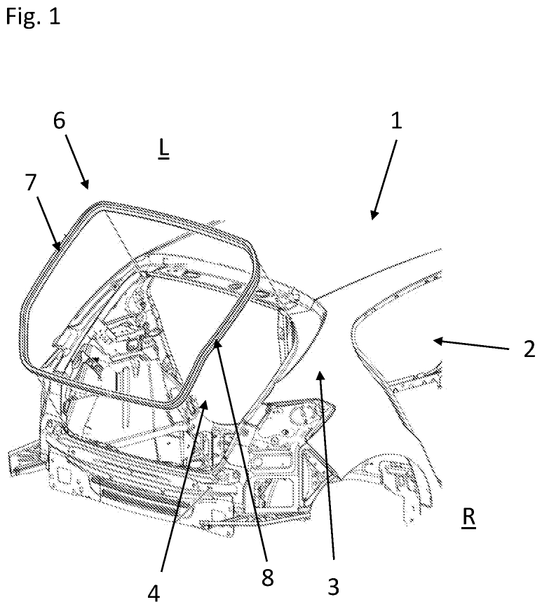

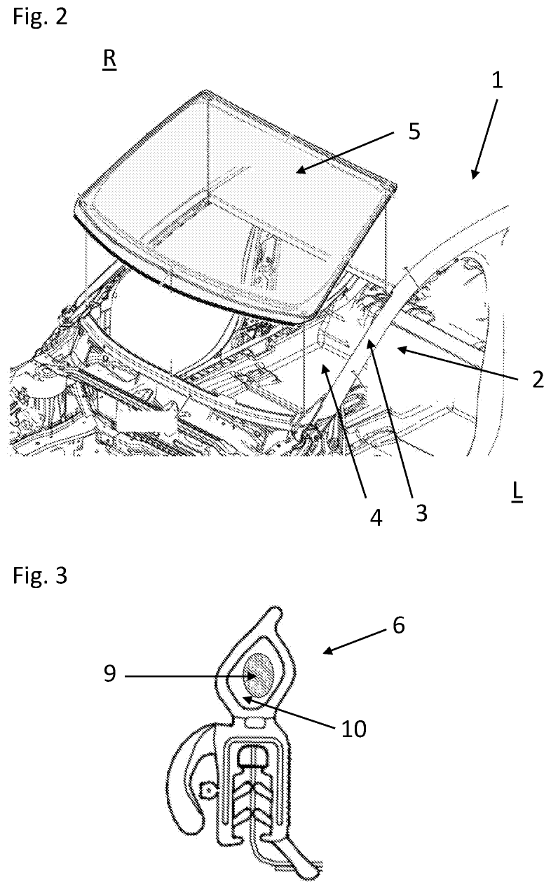

An exemplary embodiment of a system that reduce noises in an interior of a vehicle or a vehicle is illustrated in FIG. 1. Another exemplary embodiment is illustrated in FIG. 2.

The vehicle 1 has an interior 2 in which the driver and the passengers are accommodated during a journey. Noises, induced, amongst other things, by vibrations of closure elements such as vehicle doors or window elements, are produced in the interior 2 or in the driver's compartment during the journey. These noises can be reduced by the present system.

Various openings are present in the body 3 of the vehicle 1. Amongst others, the opening 4 in the form of the trunk of the vehicle 1, which can be closed by the rear door (not illustrated in FIG. 1) of the vehicle 1. In FIG. 2, an alternative opening 4 in the body 3 of the vehicle 1 is illustrated in the form of the opening 4 to be closed by the windshield 5.

Further openings in a vehicle body of a vehicle can be openings which can be closed by side doors of the vehicle, for example, or openings which are closed by windows, for instance the rear window, side windows or a panoramic window.

In this case, the openings 4 are, amongst other things, sealed by means of a sealing arrangement 6 for sealing with respect to the environment, as can be seen by way of example in FIG. 1. To this end, the sealing arrangement 6 surrounds the respective opening 4. In this case, as illustrated in FIG. 1, the opening 4 is designed to have a continuous circumference. The sealing arrangement 4 is connected to the vehicle body 3. The sealing arrangement 4 is provided between the opening 4 and the rear door in the corresponding arrangement according to FIG. 1 and is compressed upon the closure of the rear door.

The sealing arrangement 6 comprises at least a first sealing element 7 and a second sealing element 8. The rigidity of the first sealing element 7 differs from the rigidity of the second sealing element 8.

In terms of the rigidity, a non-symmetrical sealing arrangement 6 is therefore provided. It has been established that the low-frequency oscillations produced in the interior 2 of the vehicle 1 during the journey, and therefore the undesired noises, can thus be reduced.

In detail, the sealing arrangement 6 is designed to extend completely around the opening 4. In this case, the first sealing element 7 and the second sealing element 8 are arranged at opposite sides of the opening 4. Specifically, the first sealing element 7 represents the left-side sealing element and the second sealing element 8 represents the right-side sealing element. To this end, the first sealing element 7 is provided at a left side L of the opening 4, as seen in the direction of travel of the vehicle 1. The second sealing element 8 is then provided at a right side R of the opening 4, as seen in the direction of travel of the vehicle 1.

In the exemplary embodiment, which is illustrated in FIG. 1, the first sealing element 7 therefore corresponds to the left part of the sealing arrangement 6 and the second sealing element 8 corresponds to the right part of the sealing arrangement 6. In this case, the first sealing element 7 can comprise, for example, only the left vertically extending side limb of the sealing arrangement 6. The second sealing element 8 can then be comprised of only the right vertically extending side limb of the sealing arrangement 6. However, the entire left half of the sealing arrangement 6 can, for example, also be formed by the first sealing element 7. The right half of the sealing arrangement 6 is then formed by the second sealing element 8.

The first sealing element 7 and the second sealing element 8 are designed as parts of the sealing arrangement 6 which have different rigidities.

To set the rigidity of the first sealing element 7 or the second sealing element 8, either different materials or material combinations can be used or one of the sealing elements 7, 8 can also be equipped with stiffening elements 9, for example to increase the rigidity.

Such a sealing arrangement 6 is illustrated in cross-section in FIG. 3. In this case, a cavity 10 is provided within the sealing arrangement 6 or within the first sealing element 7 and/or second sealing element 8. The stiffening element 9 is arranged in this cavity 10. In this case, different stiffening elements 9 can be selected, for example, for the first sealing element 7 and the second sealing element 8, so that a different rigidity of the first sealing element 7 and the second sealing element 8 can be set via the selection of the stiffening elements 9.

In the exemplary embodiment of FIG. 1, the system is shown implemented at the rear door or the trunk of the vehicle 1. However, it can also be provided at other closure elements or vehicle doors, such as the side doors, for example, or also at further closable openings of the vehicle body. The system can therefore also be implemented at windows, such as window elements which can be opened and closed again, or such as permanently closed window elements, for example at the windshield, as illustrated in FIG. 2, or at a rear window or a panoramic window of the vehicle. In these embodiments, the sealing arrangement 6 sealing the respective opening is provided, and the sealing arrangement 6 includes sealing elements 7, 8 having different rigidities.

Advantageous configurations and variants of the exemplary embodiments can be found in the claims below. The features set out individually in the claims can be combined with one another, in any technically useful manner and present other advantageous variant embodiments.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A system for the reduction of noises in an interior of a vehicle, comprising:
at least one closure element closing an opening of a body of a vehicle; and
a sealing arrangement is provided between the opening and the closure element, the sealing arrangement includes at least a first sealing element and a second sealing element, a rigidity of the first sealing element differs from a rigidity of the second sealing element.

2. The system of claim 1, wherein the at least one closure element comprises a vehicle door.

3. The system of claim 2, wherein the vehicle door is a rear door of the vehicle.

4. The system of claim 1, wherein the at least one closure element comprises a window element moveable back and forth between an open and closed position.

5. The system of claim 1, wherein the closure element is a permanently closed window element.

6. The system of claim 1, wherein the first sealing element and the second sealing element are arranged at opposite sides of the opening.

7. The system of claim 1, wherein the first sealing element is provided at a left side of the opening, as seen in in the direction of travel of the vehicle, and the second sealing element is provided at a right side of the opening, as seen in the direction of travel of the vehicle.

8. The system of claim 1, wherein the sealing arrangement is a seal extending completely around the opening, wherein the first sealing element and the second sealing element are parts of the sealing arrangement which have respectively differing rigidities.

9. The system of claim 1, wherein the first sealing element has at least one stiffening element to achieve an increased rigidity compared to the rigidity of the second sealing element.

10. The system of claim 1, wherein the first sealing element and the second sealing element are formed from a respectively different material.

11. The system of claim 1, wherein the first sealing element is circumferentially offset from the second sealing element.

12. The system of claim 1, further comprising the vehicle.

13. A vehicle interior-noise reducing system, comprising:
a body of a vehicle, the body including an opening having a perimeter;
a closure element covering the opening; and
a sealing arrangement is provided between the opening and the closure element, the sealing arrangement disposed at the perimeter, the sealing arrangement having at least a first sealing element and a second sealing element, a rigidity of the first sealing element differs from a rigidity of the second sealing element.

14. The system of claim 13, wherein the perimeter of the opening is circumferentially continuous, wherein the sealing arrangement extends circumferentially continuously about the perimeter of the opening.

15. The system of claim 14, wherein the first sealing element is circumferentially offset from the second sealing element.

16. The system of claim 15, wherein the first sealing element is provided at a left side of the opening, as seen in in the direction of travel of the vehicle, and the second sealing element is provided at a right side of the opening, as seen in the direction of travel of the vehicle, the first sealing element providing only a left vertically extending side limb of the sealing arrangement, the second sealing element providing only a right vertically extending side limb of the sealing arrangement.

17. The system of claim 13, wherein the first sealing element has at least one stiffening element to achieve an increased rigidity compared to the rigidity of the second sealing element.

18. A method of reducing of noises in an interior of a vehicle, comprising:
closing an opening of a body of a vehicle with at least one closure element; and
positioning a sealing arrangement between the opening and the closure element, the sealing arrangement includes at least a first sealing element and a second sealing element, a rigidity of the first sealing element differs from a rigidity of the second sealing element.

19. The method of claim 18, further comprising providing the first sealing element at a left side of the opening, as seen in in the direction of travel of the vehicle, and providing the second sealing element at a right side of the opening, as seen in the direction of travel of the vehicle such that the first sealing element is circumferentially offset from the second sealing element.

20. The method of claim 18, further comprising increasing a rigidity of the first sealing element compared to the rigidity of the second sealing element by providing at least one stiffening element within the first sealing element.
